(19) United States
(12) Patent Application Publication
(10) Pub. No.: US 2004/0100128 A1
(43) Pub. Date: May 27, 2004

(54) Open roof construction for a vehicle

(76) Inventor: Peter C.L.J. Manders, Horst (NL)

Correspondence Address: Westman Champlin & Kelly, International Center Suite 1600, 900 Second Avenue South, Minneapolis, MN, 55402-3319, US

(21) Appl. No.: 10/399,818

(22) PCT Filed: Oct. 25, 2001
(86) PCT No.: PCT/NL01/00780

(30) Foreign Application Priority Data
Oct. 26, 2000 (NL) 1016489

(51) Int. Cl. B60J 7/047

(52) U.S. Cl. 296/216.03

(57) ABSTRACT

An open roof construction of a vehicle comprises a closure element that mates with a roof opening, which closure element is movable along a first longitudinal guide and a second longitudinal guide. To this end, the closure element includes a front support, which is supported in the first longitudinal guide, and a guide element, which is slidable in the second longitudinal guide. An adjusting element, which is movable in the longitudinal direction by means of an actuating element being driven from the drive unit, is disposed under said closure element, which adjusting element is fitted with the guide element and which is arranged for moving the guide element into and out of engagement with the second longitudinal guide.

The present invention relates to an open roof construction in accordance with the preamble of claim 1.

Such an open roof construction is known, for example from DE-C-42 38 944 or DE-C-42 38 945.

The object of the present invention is to provide a new open roof construction of the kind referred to in the opening sentence.

In order to accomplish that objective, the open roof construction according to the invention is characterized by the aspects of the characterizing portion of claim 1.

Since the guide element is present on an adjusting element which is controlled from the drive unit, the engagement of the guide element in the second longitudinal guide can take place independently of the movements of the closure element, thus enabling greater freedom and improved control.

Preferably, the second longitudinal guides are recessed in the fixed roof, so that said longitudinal guide hardly affects the appearance of the vehicle roof, if at all.

It is very advantageous in that case if the second longitudinal guides are disposed on side edges of a roof panel which has at least substantially the same cross dimension as the closure element of the open roof construction. This will give the roof a very attractive appearance, with the fixed roof panel being made of glass or another material.

In that case, the adjusting element is preferably so designed that the guide element is capable of lateral movement upon moving into and out of engagement with the second longitudinal guide.

It is possible in that case to construct the first longitudinal guide in the usual manner and position it under the closure element in the closed position of the closure element, whilst the guide element can be moved not only rearwards but also outwards in the direction of the second longitudinal guide, which is positioned further outwards than the first longitudinal guide when the closure element is being opened.

The invention will be explained in more detail hereafter with reference to the drawing, which shows exemplary embodiments of the open roof construction according to the invention.

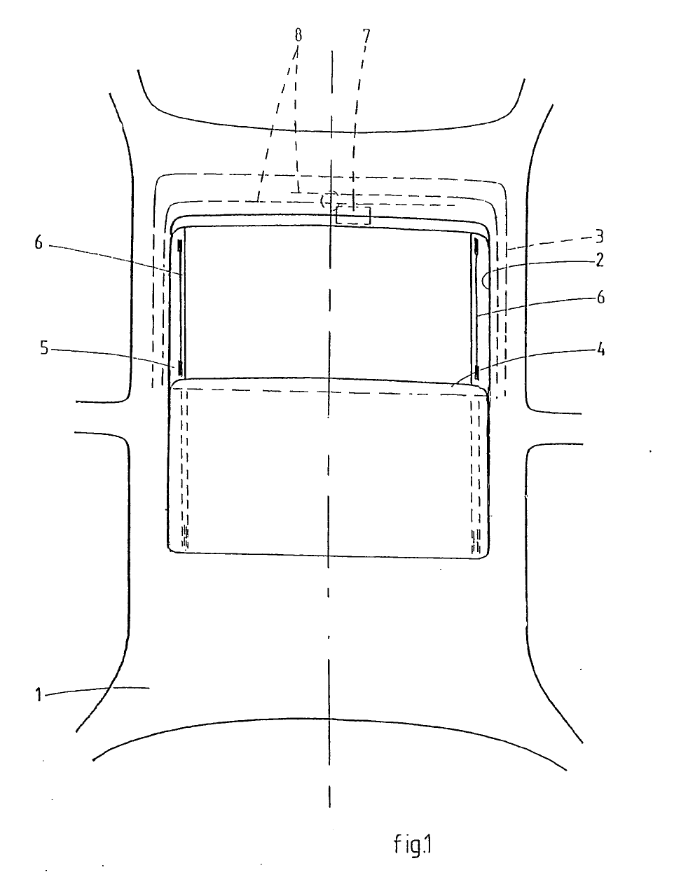

FIG. 1 is a very schematic top plan view of a vehicle roof fitted with a first exemplary embodiment of the open roof construction according to the invention.

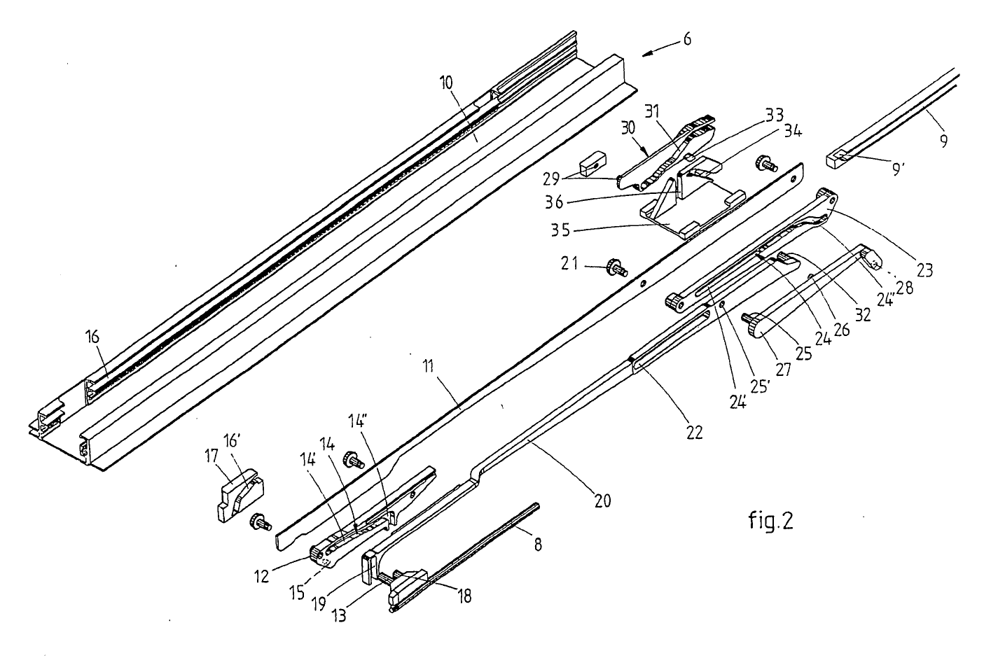

FIG. 2 is a perspective exploded view of one of the longitudinal guides and the parts that are movable therein for adjusting the closure element of the open roof construction of FIG. 1.

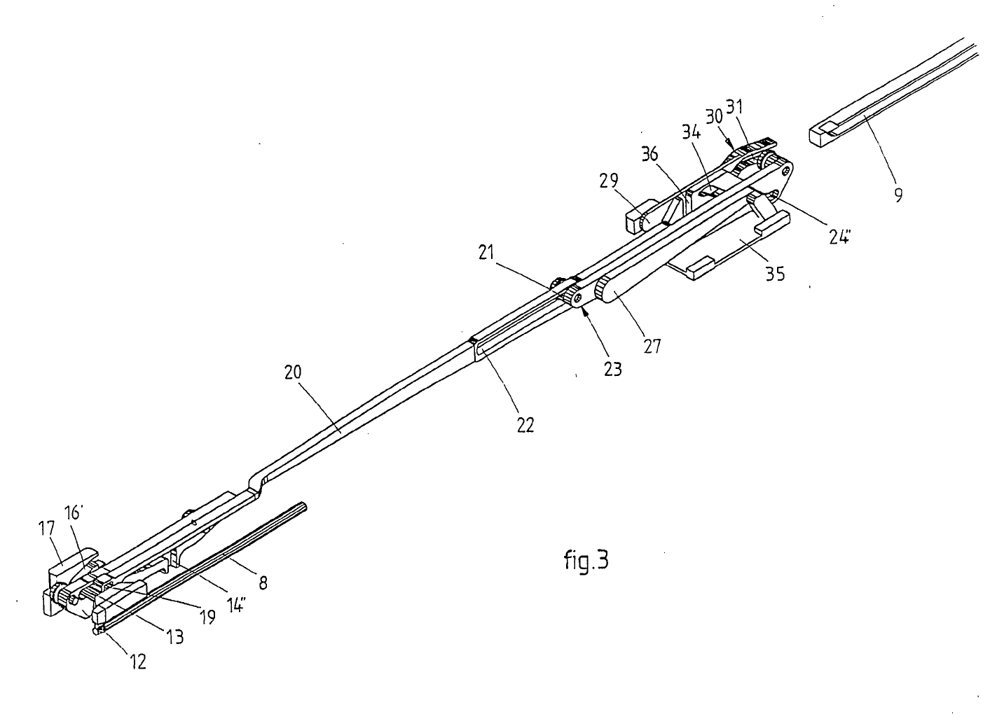

FIGS. 3-10 are perspective views of the parts of FIG. 2 in various positions of the closure element of the open roof construction of FIG. 1.

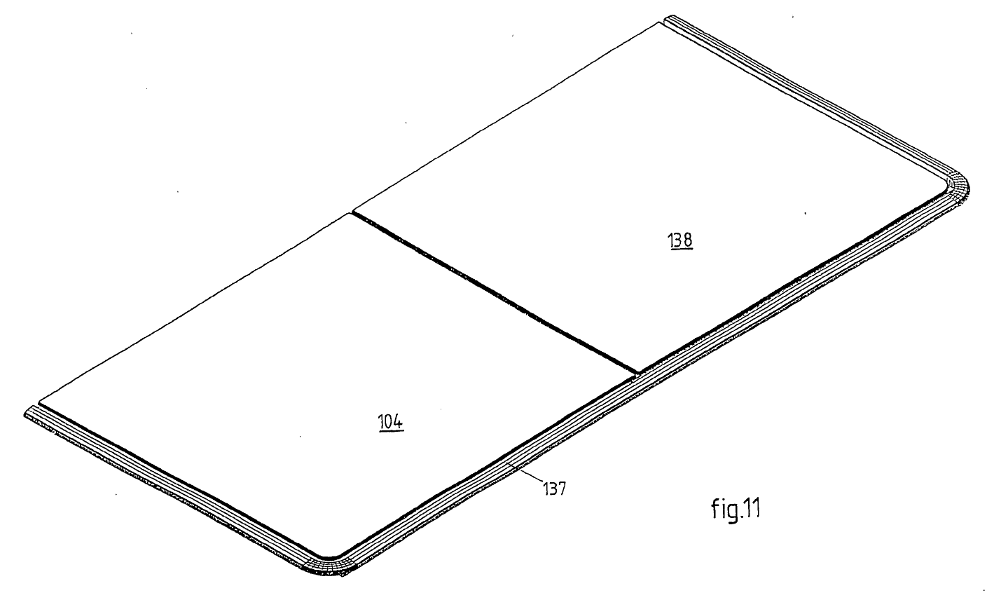

FIGS. 11-13 are perspective views of one half of a second exemplary embodiment of the open roof construction according to the invention, showing three different positions thereof.

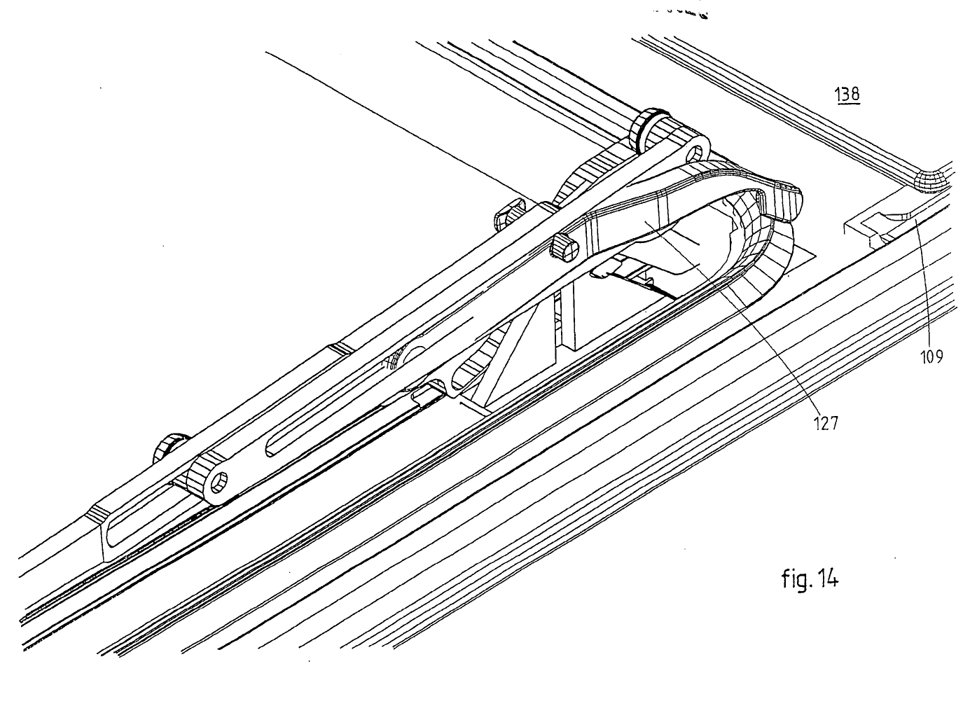

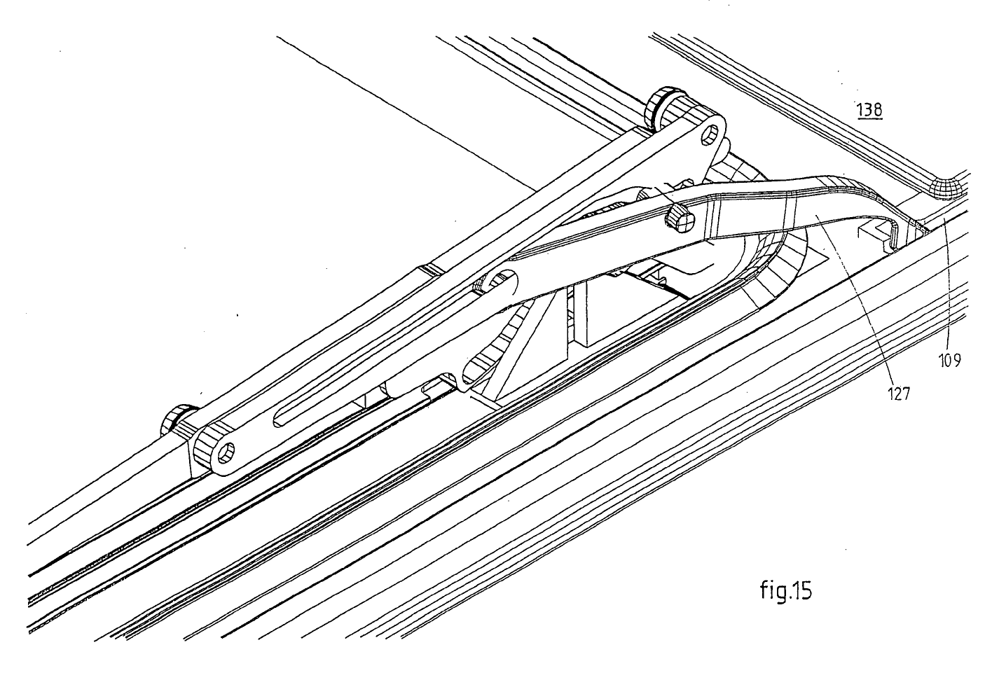

FIGS. 14-15 are two partial perspective views of a part of the height adjusting mechanism of the open roof construction of FIGS. 11-13, showing two different positions thereof.

The drawing, and in the first instance FIG. 1 thereof, shows the fixed roof 1 of a motor vehicle, such as a car, in the fixed roof 1 of which an opening 2 is formed for accommodating an open roof construction. The open roof construction comprises a frame 3 or similar stationary means to be fixed to the vehicle for movably supporting a closure element 4. In the illustrated embodiment, the open roof construction is a so-called spoiler roof of the topslider type, which in this embodiment is provided with a more or less rigid and preferably transparent panel 4 as the closure element, which is capable of selectively closing roof opening 2 or releasing it to a smaller or greater extent. Panel 4 is to this end laterally supported by operating mechanisms or height adjusting mechanisms 5, which are slidably accommodated in first longitudinal guides 6, which are mounted on frame 3 or form part thereof and which extend in parallel relationship in the longitudinal direction on either side of roof opening 2. Said operating mechanisms 5 can be moved synchronously in the first longitudinal guides 6, thus moving panel 4 not only in longitudinal direction but also in vertical direction. To this end, the operating mechanisms 5 are operated from a driving apparatus 7, such as an electric motor, for example via driving cables 8 that are resistant to compressive and tensile strain.

Present on the fixed roof 1, rearwards of the roof opening 2, are two parallel second longitudinal guides 9, in which a guide element (yet to be described) is guided for supporting the panel in rearward positions thereof.

FIG. 2 shows the parts of the operating mechanism 5 on one side of the roof opening of the respective first longitudinal guides 6 and second longitudinal guides 9. As the figure shows, the longitudinal guide 6 is formed of an (aluminium) extruded section in this embodiment, in which a groove 10 is present which is open at the upper side, in which groove the parts are guided.

FIG. 2 shows a panel part 11, which is mounted on the underside of the panel and on which further parts can be mounted. Present at the front side of the panel part 11 is a front support 12, which is in constant engagement with a driving pin 13 that is fixed to the driving cable 8. The engagement between said driving pin 13 and the front support 12 takes place via a slot 14 in the front support 12, which slot 14 includes a front slot portion 14′, which extends downwards and rearwards at a small angle from the front end, whilst a rear slot portion 14″ extends in vertical direction.

A pin 15 on the front support 12, which functions as a pivot, is in engagement with a horizontally open guide groove 16 in the first longitudinal guide 6, which guide groove 16 includes a downwardly curved portion 16′ at its front end, which portion 16′ is formed in a separate part 17 of the first longitudinal guide 6, and which is used for the height adjustment of the front side of the panel 4.

Another pin is formed on the driving cable 8 in the form of an actuating pin 18, which is in engagement, via a vertical groove 19, with an actuating element in the form of a section 20 which is slidable under the panel, which section 20 is slidably guided in a horizontal slot 22 with respect to panel part 11, some distance behind the vertical groove 19, due to the engagement of a fixing screw 21 that is screwed in the panel part.

The fixing screw 21 is also used for fixing a link 23 to the panel part 11, which link is provided with a curved guide slot 24 comprising a front slot portion 24′, which extends at least substantially parallel to the panel 4, and a rear curved portion 24″. The guide slot 24 is engaged by a pivot pin 25 and a guide pin 26 of an arm 27 functioning as an adjusting element, on the rear end of which a guide element in the form of a horizontal pin 28 is present, which pin can move into engagement with the horizontally open groove of the second longitudinal guide 9. The pivot pin 25 is also pivotally connected to the actuating section 20 through engagement in a hole 25′ therein. The arm thus follows the movements of the section 20.

The operating or height adjusting mechanism comprises a number of additional parts near the rear end of the first longitudinal guide 6. A first part is a pivoting arm 30 which pivots about a pivot 29, which pivoting arm 30 includes a curved slot 31 which is open at its rear end, in which a pin 32 formed on the front end of the actuating section 20 can engage. The pivoting arm 30 itself has a guide pin 33, which is in engagement with an-at least partially sloping guide slot 34 in a control element 35, which is capable of sliding movement over a small adjusting distance in the first longitudinal guide 6. The control element 35 is furthermore provided with a vertical adjusting slot 36 which is open at the upper side, with which the pin 32 of the section 20 is temporarily in engagement.

The operation of the above-described embodiment of the open roof construction according to the invention will now be explained with reference to FIGS. 3-10.

In FIG. 3, the panel of the open roof construction is in its closed position, in which it closes the roof opening. The driving cable 8 is in the front position, in which position the pin 13 is located at the front end of the front slot portion 14′ of the slot 14. The actuating pin 18 is positioned approximately at the top of the vertical groove 19 of the actuating section 20, whilst the pin 15 of the front support 12 is positioned at the bottom of the front portion 16′ of the guide groove 16. The actuating section 20 is in its front position, so that the fixing screw 21 is positioned at the rear end of the slot 22 in the section 20. The pin 32 on the actuating section 20 is present at the front end of the slot 31 of the downwardly pivoted pivoting arm 30, and it is furthermore positioned at the bottom of the vertical adjusting slot 36 of the control element 35. The guide pin 33 is positioned near the lower, rear open end of the guide slot 34. The arm 27 occupies its front position with respect to link 23, so that the pivot pin 25 abuts against the front end of the guide slot 24, whilst the guide pin 26 is still positioned in the front slot portion 24′ of the guide slot 24.

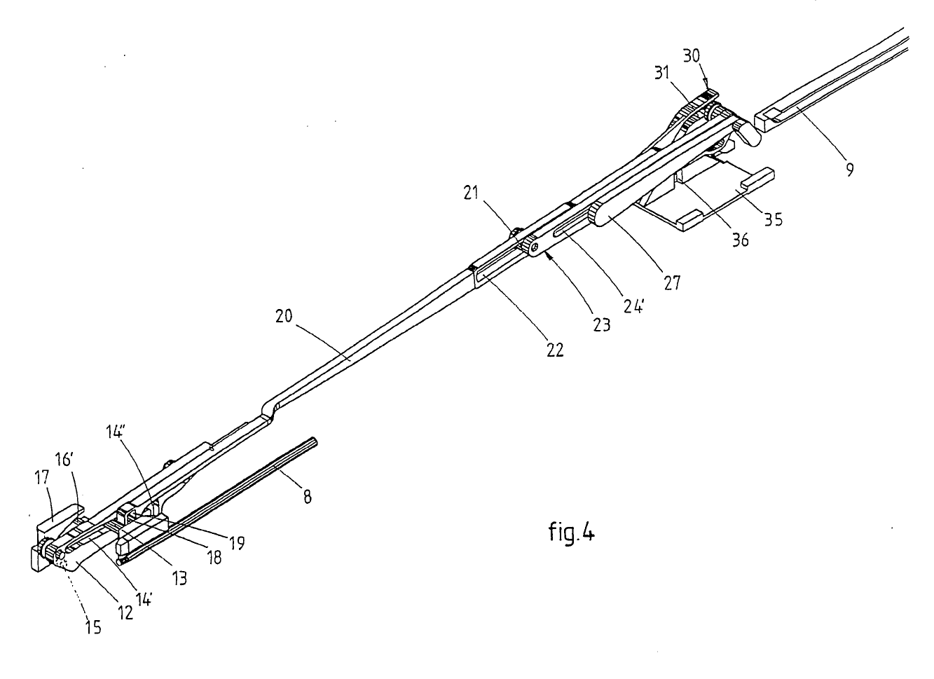

FIG. 4 shows the position in which the driving cable 8 has been moved rearwards over a small distance. During this rearward movement, the pin 13 of the driving cable 8 has moved to the rear. The front support 12 remains stationary or substantially stationary during said movement as a result of the engagement of the pin 15 in the front portion 16′ of the guide groove 16. After all, the front portion 16′ extends in vertical direction, thus crossing the slot 14, as a result of which the rearward movement of the front support 12 is determined by the manner in which the slot 14 and the guide groove 16 extend relative to each other. Only when the slot 14 allows movement in vertical direction of the front support 12 can the sliding pin 15 start to move through the guide groove 16.

The actuating section 20 is carried along by the actuating pin 18 of the driving cable 18 via the vertical groove 19, with the vertical groove 19 allowing any movements in vertical direction of an actuating section 20 with respect to the driving cable 8. The slot 22 of the actuating section 20 starts to move along the fixing screw 21, so that the section 20 is led to the rear. Engagement of the pin 32 on the rear end of the section 20 in the vertical adjusting slot 36 of the control element 35 causes the control element 25 to be carried along to the rear, and because of the movement of the control element 35, and thus of the guide slot 34, said guide slot will move with respect to the guide pin 33 on the pivoting arm 30, so that the pivoting arm 30 will pivot about the pivot 29. The pin 32 on the section 20 also moves through the slot 31 in the pivoting arm 30 upon its rearward movement. The guide pin 32 is moved upwards both as a result of the slope of slot 31 and as a result of the upward pivoting movement of the pivoting arm 30, as a result of which the section 20, and thus the panel 4, are moved upwards in a controlled manner. The pivoting movement of the pivoting arm 30 also makes it possible to achieve a substantial lifting height of the panel 4 in spite of the small overall height of pivoting arm 30, because the slot 31 can pivot upwards.

The section 20 also carries along the arm 27 in rearward direction via the pivot pin 25, during which movement the guide pin 26 moves through the guide slot 24 of the link 23. Also the pivot pin 29 moves through the straight portion of said slot 24

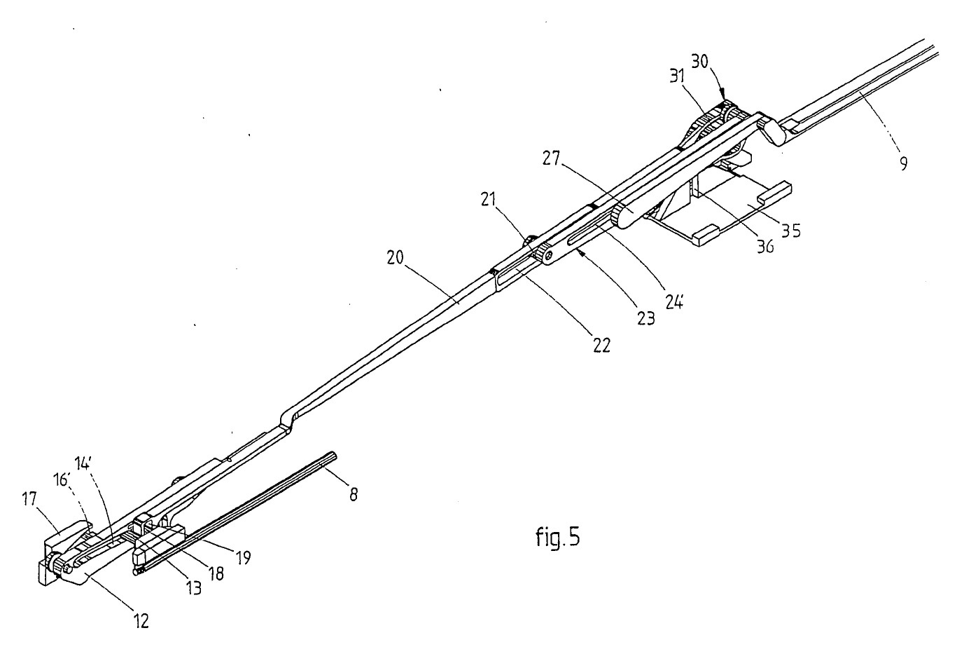

In FIG. 5, the driving cable 8 is shown to have moved even further in rearward direction, during which movement the driving pin 13 has reached a slightly downwardly extending part of the front slot portion 14′ of the slot 14 in the front support 12, thus causing the pin 15 to be moved slightly rearwards and upwards in the guide groove 16. The above-described movements of parts near the rear side of the panel and/or of the height adjusting mechanism are continued. As the figure shows, the guide pin 32 on section 20 has left the adjusting slot 35 of the control element 35 in the meantime, and the guide pin 33 of the pivoting arm 30 has reached the upper end of the guide slot 34, so that the pivoting arm 30 has reached the maximally upwardly pivoted position. The control element 35 will further remain stationary.

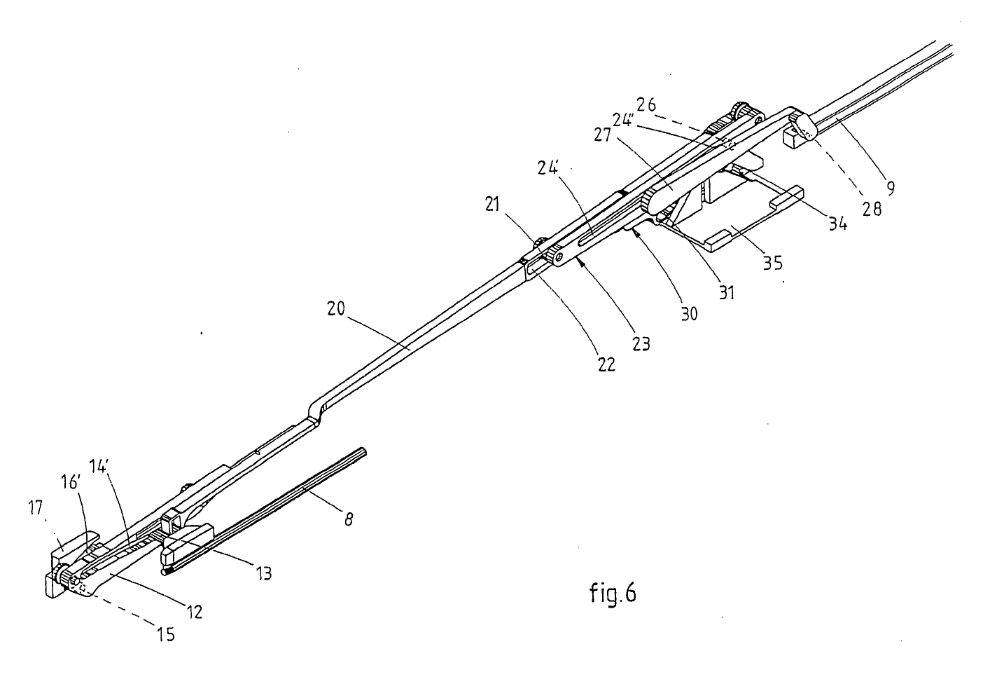

In FIG. 6, the driving cable 8 is shown to have moved even further in rearward direction, and the arm 27 is shown to have pivoted downwards as a result of the guide pin 26 moving through the rear slot portion 24″ of the guide slot 24 upon further movement to the rear of the pivot pin 25 via the section 20. The pin 28 on the arm 27 has reached the upwardly curved front portion 9′ of the second longitudinal guide 9 during this movement.

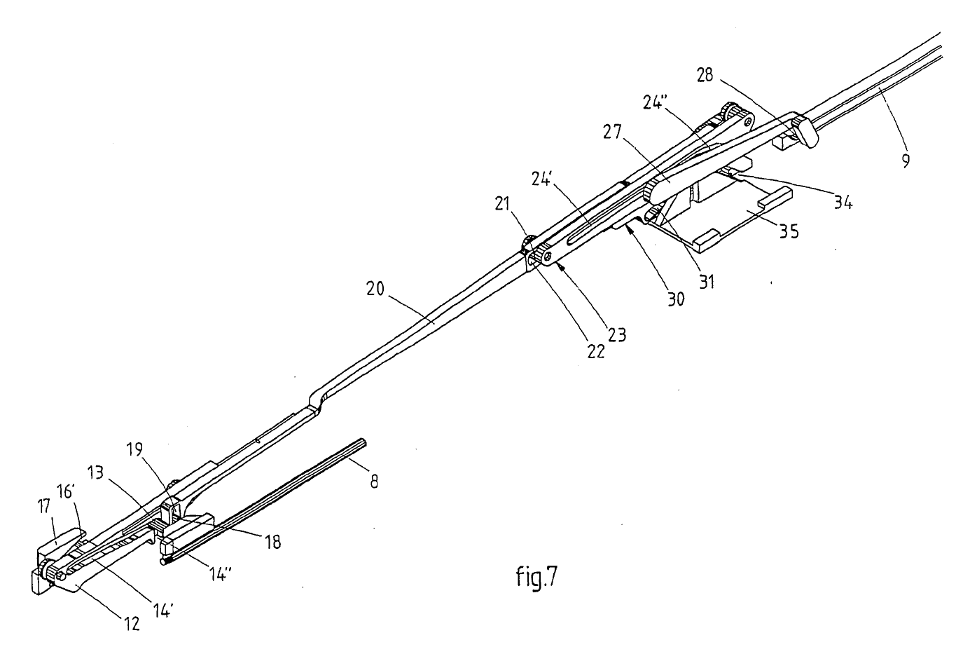

In FIG. 7, the driving cable 8 has moved so far to the rear that the driving pin 13 has arrived at the upper end of the rear, vertical slot portion 14″ of the slot 14. In the meantime, the arm 27 has been moved so far rearwards by the section 20 that it has completely entered the second longitudinal guide 9, as a result of which panel 4 is supported by the second longitudinal guide 9 via the arm 27.

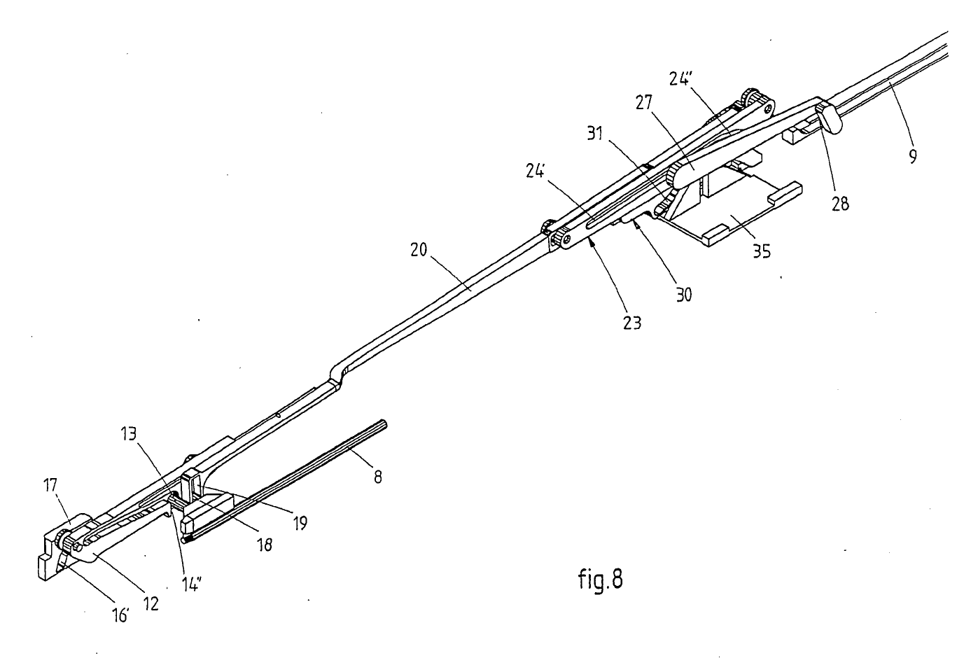

In FIG. 8, the driving pin 13 has started its movement through the vertical rear slot portion 14″ of the slot 14, as a result of the fact that the upward locking engagement of the front support 12 by said pin 13 has been released and the pin 15 is now allowed to move through the guide groove 16 while lifting the front support-13, and consequently the front side of the panel 4. This does not interfere with the vertical movement of the front end of the section 20, because the vertical groove 19 of the section 20 can slide pas the actuating pin 18 of the driving cable 8. In the meantime, the pin 32 of the section has left the open rear end of the slot 31 of the pivoting arm 30, as a result of which the panel 4 has become detached from the height adjusting mechanism and the panel 4 is now supported by means of the arms 27. The panel 4 will also be moved to the rear now, because the driving pin 13 carries the front support 12 along via the vertical rear slot portion 14″ in the front support 12, as a result of which the panel 4 will make a translating movement.

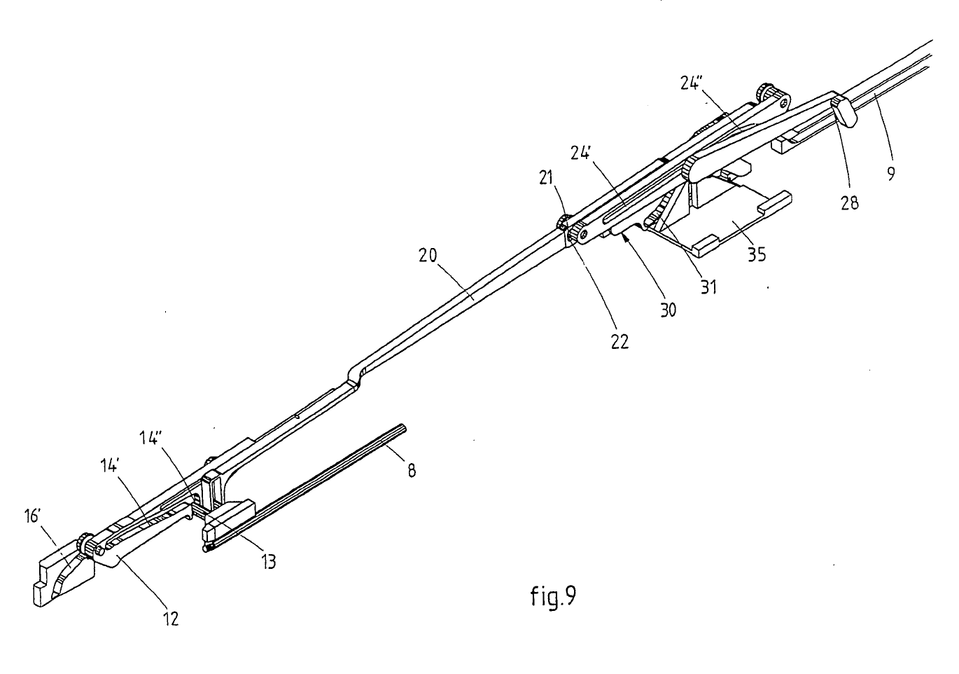

In FIG. 9, the pin 15 has reached -the rear end of the front portion 16′ of the guide groove 16, and said sliding pin 15 will move further through the horizontal guide groove 16 as a result of being driven by the driving pin 13 of the cable 8, which acts on the front support 12

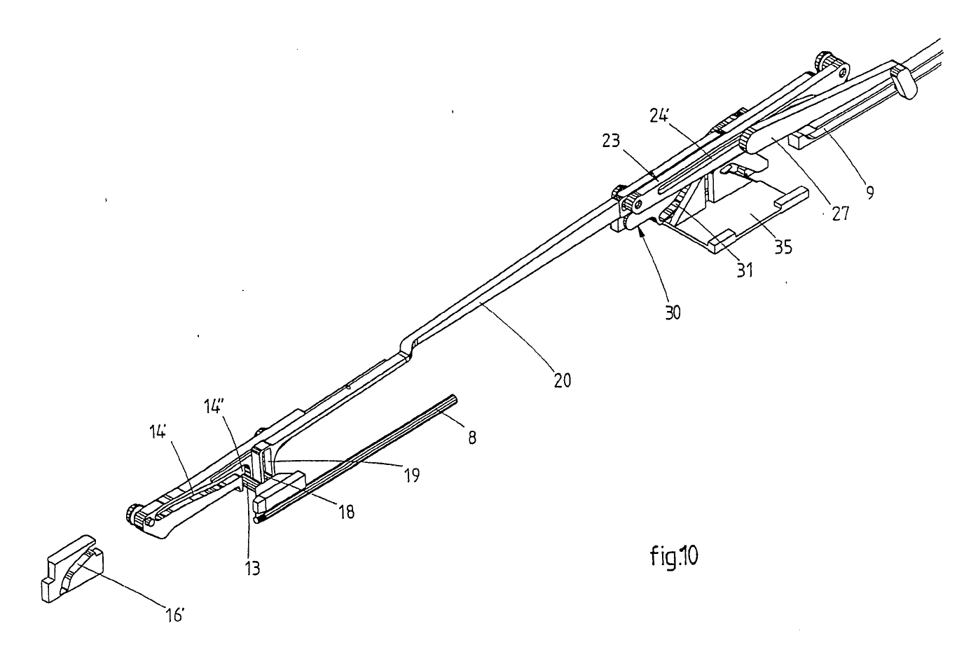

In FIG. 10, the sliding pin 15 has moved some distance through the guide slot 1b already.

FIGS. 11-13 show a part of a second embodiment of the open roof construction according to the invention. The panel 104 can be distinguished, whilst furthermore a fixed roof panel 138 is mounted within a rim 137 of the open roof construction, which roof panel is preferably made of the same material as the panel 104, but which also be made of another material, of course. As the figure shows, the cross dimension of the roof panel 138 is identical to that of the panel 104, so that an attractive-looking unit is formed in the closed condition of the panel 104. In the closed position of the panel 104, the upper side of the panels 104 and 138 also lie at least substantially in the same plane.

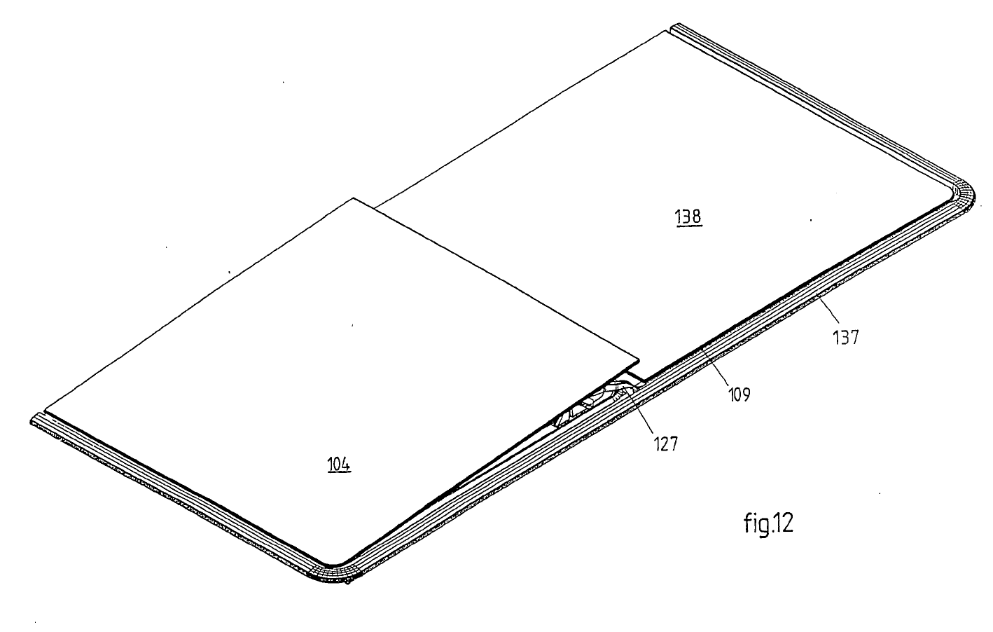

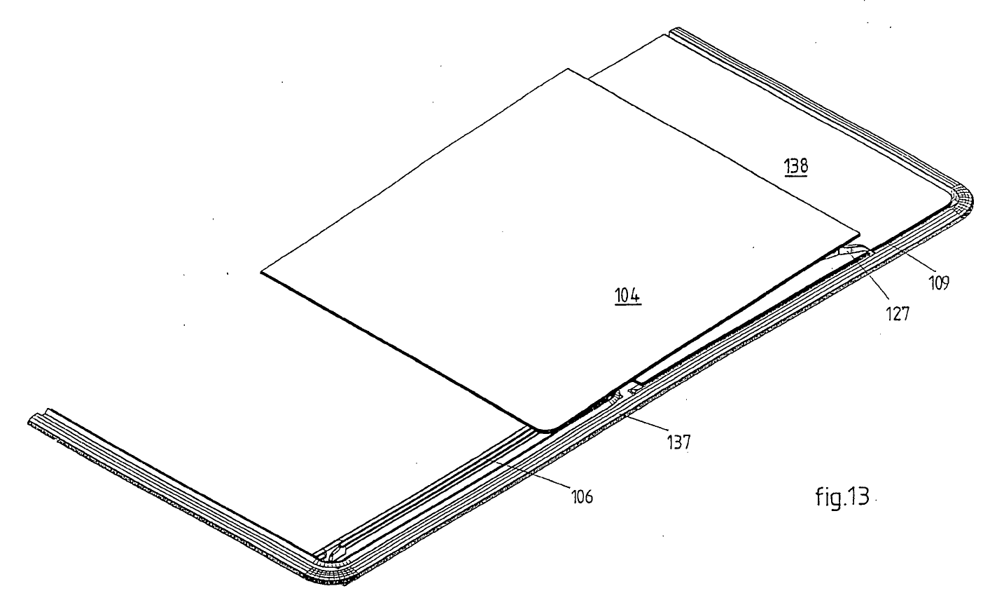

FIG. 12 shows the panel 104 in the ventilating position, in which position the panel 104 has moved upwards at the rear side by the height adjusting mechanism but has not moved to the rear yet. An arm 127 can be distinguished, which has pivoted downwards from the panel 104. The figure also shows, however, that the arm 127 has also pivoted outwards so as to come into engagement with the second longitudinal guide 109 that is present on the side edge of the roof panel 138, that is, outwards of the longitudinal guide 106 (FIG. 13). In this manner it is possible to use a roof panel 138 of the same width with an associated second longitudinal guide 109, which is disposed further outwards than the first longitudinal guide 106, without any special modifications of the first longitudinal guide 106 or the sealing of the panel 104 being required. In FIG. 13, the panel 104 has moved to the rear, in which position it is supported on the rear side by the arm 127 that engages in the second longitudinal guide 109.

FIGS. 14 and 15 very schematically show a possible embodiment of the arm 127, which is suspended via a spatial pivot at the front end, so that the arm 127 can pivot downwards as well as outwards, whilst the guide slot 124 of the link 23 must be arranged for effecting lateral movement of the guide pin 127 that engages in the guide slot 124.

The invention is not restricted to the embodiments as described above and shown in the drawings, which can be varied in several ways without departing from the scope of the invention as defined in the appended claims. Thus it is possible to design the rear roof panel 138 as a movable unit, for example as a tilting roof. The second longitudinal guides may be fixed to said movable roof panel, in which case the front panel 104 will move along when it is positioned above the rear panel 138. According to another possibility, a different type of roof member, which may or may not be movable, is disposed behind the roof opening for the panel 104.

1. An open roof construction for a vehicle having an opening in its fixed roof, comprising a stationary part to be fixed to the roof and a closure element which is movably supported by said stationary part and which can be adjusted by means of a drive unit, which closure element is movable between a closed position, in which it closes the roof opening, and an open, rearward position at least partially above a roof portion which is disposed rearwards of the roof opening, in which position the roof opening is at least partially released, said stationary part comprising at least a first longitudinal guide extending along the roof opening and a second longitudinal guide rearwards of the roof opening, which is accessible from the outside, whilst the closure element is supported near its front side by a front support, which is slidably supported in said first longitudinal guide, and which is supported rearwards thereof by supporting means including a height adjusting mechanism, which is present in said first longitudinal guide and which supports the closure element at least in two front positions, and a guide element which is slidable in the second longitudinal guide and which supports the closure element at least in rearward positions, characterized in that an adjusting element, which is movable in the longitudinal direction by means of an actuating element that is controlled from the drive unit, is disposed under said closure element, which adjusting element is fitted with said guide element and which is arranged for moving the guide element into and out of engagement with the second longitudinal guide.

2. Open roof construction according to claim 1, wherein the adjusting element is an arm which is capable of sliding and pivoting movement under the closure elements, on a free rear end of which arm the guide element is mounted.

3. Open roof construction according to claim 2, wherein the arm includes a pivot near its front end, which pivot is slidable along a guide under the closure element, whilst the arm furthermore includes a forcing guide, which forces the arm to pivot upon movement thereof with respect to the closure element, wherein the arm is preferably connected to the actuating element via said pivot.

4. Open roof construction according to claim 3, wherein the forcing guide is provided with a curved guide slot formed under the closure element, in which a guide pin which is fixed to the arm engages, which guide slot may have an extension at the rear end, in which the guide pin is present when the guide element is in engagement with the second longitudinal guide and the closure element is out of engagement with the height adjusting mechanism, wherein the configuration of the guide slot may be such that the closure element, upon moving out of engagement with the height adjusting mechanism, is first moved to a higher position and then to a lower pivoted position.

5. Open roof construction according to any one of the preceding claims, wherein the actuating element is a section which is capable of sliding movement under the closure element.

6. Open roof construction according to claim 5, wherein the actuating element is connected, via a vertically adjustable connection, to a driving slide of the drive unit, which is slidable in the first longitudinal guide.

7. Open roof construction according to claim 5, wherein said vertically adjustable connection includes a vertically extending groove which is formed in the section of the actuating element, as well as an actuating pin which is connected to the drive unit.

8. Open roof construction according to any one of the preceding claims, wherein said height adjusting mechanism includes a pin-slot joint between the stationary part and the actuating element, and wherein at least one end of the slot is open so as to enable the pin to enter and leave the slot.

9. Open roof construction according to claim 8, wherein the slot of said pin-slot joint is formed in the stationary part and the pin is formed on the actuating element.

10. Open roof construction according to claim 9, wherein the slot of said pin-slot joint is formed in a pivoting arm that is pivotally connected to the stationary part.

11. Open roof construction according to claim 10, wherein a control element is present in the guide rail for pivoting the pivoting arm of the height adjusting mechanism, which control element can be actuated by the actuating element on the closure element.

12. Open roof construction according to claim 11, wherein the pin of the height adjusting mechanism also engages in an at least substantially vertical adjusting slot of the control element, which is open at the upper end, so as to actuate the control element.

13. Open roof construction according to claim 11 or 12, wherein the control element includes a slot which extends in longitudinal and vertical direction, in which a pin which is formed on the pivoting arm of the height adjusting mechanism engages.

14. Open roof construction according to any one of the preceding claims, wherein the closure element includes a height compensation mechanism on the front side, which comprises a groove formed in the stationary part and a pin formed on the closure element, as well as a slot which is connected to the closure element and a pin which is connected to the drive unit, wherein the groove and the slot cross one another.

15. Open roof construction according to any one of the preceding claims, wherein the second longitudinal guide is recessed in the fixed roof.

16. Open roof construction according to any one of the preceding claims, wherein the second longitudinal guide is a horizontally open groove, whilst the guide element is a horizontal pin, which is capable of engaging in said groove from one side.

17. Open roof construction according to claim 15, wherein the second longitudinal guides are disposed at the side edges of a roof panel which has at least substantially the same cross dimension as the closure element of the open roof construction.

18. Open roof construction according to claim 17, wherein the adjusting element is so designed that the guide element is capable of lateral movement upon moving into and out of engagement with the second longitudinal guide.

19. Open roof construction according to claims 3 and 18, wherein the forcing guide of the arm extends in lateral direction for effecting the lateral movement of the arm and the guide element.

20. Open roof construction according to claims 4 and 29, wherein the guide slot extends in transverse direction.

21. A vehicle fitted with an open roof construction according to any one of the preceding claims.
